(19) United States
(12) Patent Application Publication
(10) Pub. No.: US 2012/0085778 A1
(43) Pub. Date: Apr. 12, 2012

(54) Disposable toothpaste dispenser cover

(76) Inventors: Joseph Fallacara, East Hampton, NY (US); Jeanine Fallacara, East Hampton, NY (US); Robert F. Herber, St. James, NY (US); Barbara Herber, St. James, NY (US)

(21) Appl. No.: 12/924,983

(22) Filed: Oct. 12, 2010

(51) Int. Cl. B67D 7/00; B65D 35/24

(52) U.S. Cl. 222/1; 222/106

(57) ABSTRACT

A disposable toothpaste dispenser cover configured to prevent direct contact between the toothpaste dispenser and a toothbrush so as to prevent the transfer of germs from one person to the next person using the toothpaste dispenser is provided. Also provided is a method for using the disposable cover and a tooth care kit containing the same.

### FIELD OF THE INVENTION

The present invention relates generally to dental hygiene products. In particular, the present invention relates to a removable, disposable toothpaste cover used to protect the transfer of germs from a toothpaste tube to a toothbrush.

### BACKGROUND OF THE INVENTION

Many diseases are transferred from one person in a household to the next by using the same tube of toothpaste. Looking at a toothbrush under a microscope would clearly show that it is often infested with bacteria and other microorganisms which can be transferred to a toothpaste tube when the toothpaste is being dispensed. This leaves the toothpaste tube with germs on the dispensing end that can be transferred to the toothbrush of the next user of the toothpaste dispenser. So, if the first user of the toothpaste has Strep throat, chances are that the bacterium that causes Strep throat will be transferred from the toothbrush of the infected person to the toothpaste tube. Then, when the next person uses the toothpaste, chances are that they will become infected with and contract Strep throat. One way to avoid this is for each person to have there own toothpaste tube, but this is seldom followed.

Thus, in view of the foregoing, what is needed in the market is a removable, disposable toothpaste cover that protects the transfer of germs from the toothpaste to the toothbrush when being dispensed. The present invention provides such a device and is further described in the section and drawings discussed below.

### SUMMARY OF THE INVENTION

The present invention is directed to a disposable toothpaste dispenser cover comprising a body having an outer surface, an inner surface, a first rim and a second rim. The first and second rims define first and second openings and are positioned in-line and apart from one another so as to define a lumen that extends from the first opening to the second opening. The inner surface has at least one barb configured to releasable engage an area around a dispensing orifice of the toothpaste dispenser so as to retain the disposable cover to the toothpaste dispenser. The cover is positioned so that the dispensing orifice of the toothpaste dispenser is continuous with the lumen of the cover so that toothpaste dispensed from the toothpaste dispenser exits the first opening of the cover. Once the toothpaste is dispensed, the user can remove the disposable cover from the toothpaste dispenser and discard accordingly.

This configuration prevents the dispensing orifice and surrounding area from coming in direct contact with a toothbrush or a counter. That is, a user can dispense toothpaste on to the toothbrush from the dispenser without coming in direct contact with the toothpaste dispenser and also when the toothpaste dispenser is placed on a counter the dispensing orifice and surrounding area is shielded from coming in direct contact with counter. Thus, shielding the toothpaste dispenser form direct contact with multiple toothbrushes and/or counters prevents the transfer of microorganisms, viruses and germs in general from the toothbrush or counter to the toothpaste dispenser and subsequently to the next person using the toothpaste dispenser.

Another embodiment of the present invention is directed to a disposable toothpaste dispenser cover comprising a body having an outer surface, an inner surface, a first rim and a second rim. As discussed above, the first and second rims define first and second openings that are positioned in-line and apart from one another so as to define a lumen. The lumen extends from the first opening to the second opening. The inner surface of the cover has a securing flap connected thereto by a hinge member located within the lumen below the first rim. The securing flap is configured to move from a first position to a second position on the hinge member and comprises at least one barb. As discussed above, the barb is configured to releasable engage an area around a dispensing orifice of the toothpaste dispenser so as to retain the disposable cover on the toothpaste dispenser. In the second position, the securing flap is located between the toothpaste dispenser and the inner surface of the cover and provides pressure to the barb so as to retain the cover on the toothpaste dispenser while toothpaste is being dispensed.

Once in place, the dispensing orifice of the toothpaste dispenser is continuous with the lumen of the cover so that toothpaste dispensed from the toothpaste dispenser flows freely from the first opening of the cover. Once the toothpaste is dispensed, the user can remove the disposable cover from the toothpaste dispenser by either squeezing and pulling the cover away from the dispenser or just pulling away from the dispenser. As discussed above, this arrangement prevents the transfer of germs from one user to another thereby preventing the spreading of such diseases as Strep throat, common colds, influenza, various types of viruses, gingivitis, and other communicable diseases.

The present invention is also directed to a method for dispensing toothpaste from a toothpaste dispenser hygienically comprising placing the disposable toothpaste dispenser cover discussed herein on the toothpaste dispenser so as to protect the toothpaste dispenser from coming in direct contact with a toothbrush receiving toothpaste from the toothpaste dispenser. Once in position, the toothpaste dispenser is activated to dispense toothpaste onto the toothbrush without coming in direct contact with the toothbrush. Once the toothpaste has been dispensed, then the cover is removed from the toothpaste dispenser for proper disposal.

The present invention is also directed to a tooth care kit comprising a toothpaste dispenser for dispensing toothpaste and at least one disposable toothpaste dispenser cover as described therein that is configured to fit the toothpaste dispenser. The kit can also optionally have at least one toothbrush.

The following sections and figures describe the invention in greater detail and specificity.

### BRIEF DESCRIPTION OF THE FIGURES

FIG. 1 is a partial sectional side view of one embodiment of the disposable cover of the present invention;

FIG. 2 is a top perspective view of the embodiment of the disposable cover of the present invention shown in FIG. 1;

FIG. 3 is a part sectional side view of the embodiment of FIG. 1 positioned on a toothpaste dispenser

FIG. 4 is a partial sectional side view of one embodiment of the disposable cover of the present invention;

FIG. 5 is a top perspective view of the embodiment of the disposable cover of the present invention shown in FIG. 3; and

FIG. 6 is a part sectional side view of the embodiment of FIG. 3 positioned on a toothpaste dispenser.

### DETAILED DESCRIPTION OF THE INVENTION

The present invention is directed to a toothpaste cover specifically configured to be placed on the dispensing end of a toothpaste dispenser so as to protect it from the transfer of germs onto and to a toothbrush receiving toothpaste from the dispenser. In many families, brothers, sisters and parents share one or two tubes of toothpaste. Each time a family member uses the toothpaste, he or she rubs the bristles of their toothbrush against the dispensing orifice of the toothpaste tube so as to assure that the toothpaste being dispensed lands on the toothbrush and not in the sink. Quite often the toothbrush is pressed against the orifice and surrounding areas to terminate the stream of toothpaste from the toothpaste dispenser. In doing so germs, bacteria, viruses, fungi, and other microorganisms that cause disease and various gum conditions that harbor on the toothbrush are transferred to the toothpaste dispenser for the next user to contract.

It has been found that this is one that communicable transmittable diseases can be transmitted from one person to the next. That is why it is often seen when one person gets strep throat often several or all of the people in the family also get strep throat. Similarly, that is also why common cols and the like are passed from one family member to the next during cold and influenza period.

One way to prevent the transmitting of disease from one person to person via a shared tube of toothpaste is for each person in a household to have their own tube of toothpaste instead of a shared tube. This is not only expensive but also often impracticable since keeping tabs on which tube belongs to who is confusing and often breached. In addition, should a person place his or her toothbrush on a counter and germs are transferred to the counter, when a person places and uncapped tube of toothpaste onto the same counter the tube will pick up these germs and transmit them back to the user of the toothbrush.

The present invention is directed to a simple protecting cover that is configured to easily fit on the dispensing end of a toothpaste dispenser so as to protect the dispenser from coming in direct contact with either a toothbrush receiving toothpaste from the toothpaste dispenser or a counter. The toothpaste dispenser cover is made from a flexible material that easily slips onto the dispenser, stays engaged when toothpaste is dispensed passed or through the cover and can easily be removed after the toothpaste has been dispensed for disposal. Once removed the cap of the toothpaste dispenser can be put in place so as to protect the orifice from collecting germs when not being used.

The disposable toothpaste dispenser covers can be sold in a package that can act as a dispenser or a permanent dispenser can be provided and refills purchased when needed. Either way the dispenser aids in preventing contact with individuals so as to reduce the chance of contamination caused by touching or holding.

The present invention may be understood more readily by reference to the following detailed description of the invention taken in connection with the accompanying figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

While the invention is described in the context of a particular shaped toothpaste dispenser, that is simply to assist the reader in understanding one particular use of the present invention and in light of the specification it will be clear that the invention can be used with any toothpaste dispenser that dispenses toothpaste from a capped orifice whether for home use or in a commercial setting. For example, this can be used with a standard squeezable toothpaste tube regardless of whether the tube uses a screw-off cap, a snap on cap or is a pump tube. As long as it dispenses toothpaste from an orifice having some sort of neck that extends away form the tube, the present invention can be used.

Also, as used in the specification and including the appended claims, the singular forms “a,” “an,” and “the” include the plural, and reference to a particular numerical value includes at least that particular value, unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

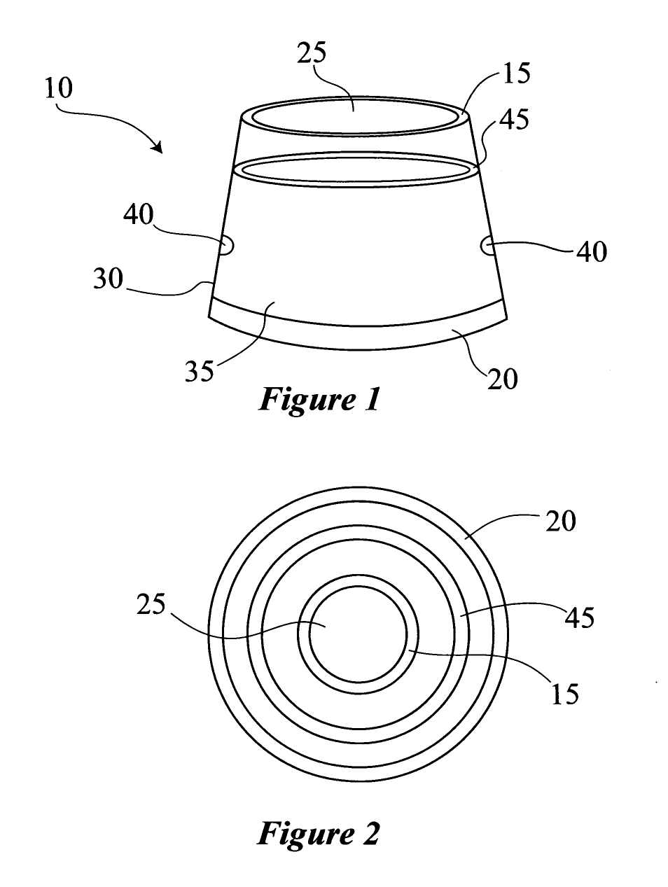

The following discussion includes a description of a toothpaste dispenser cover of the present invention, related components and exemplary methods of employing the disposable cover so as to prevent the spread of germs from one person to the next in accordance with the principles of the present disclosure. As stated above, alternate embodiments are also disclosed. Reference will now be made in detail to the exemplary embodiments of the present disclosure, which are illustrated in the accompanying figures. Turning now to FIGS. 1-6, there are illustrated components of the disposable cover in accordance with the principles of the present disclosure.

FIG. 1 shows a part sectional side view of one embodiment of the disposable cover for a toothpaste dispenser of the present invention 10. The disposable cover 10 has an outer surface 30 and inner surface 35 as well as a first rim 15 and a second rim 20. The first rim 15 defines the outline of a first opening and the second rim 20 defines the outline of a second opening. The first and second rims are configured so as to be in-line and separated apart from one another. The first and second openings are connected by a lumen 25 that is defined by the inner surface 35 of the disposable cover.

In this embodiment of the present invention, the first rim 15 has a diameter that is smaller than the diameter of the second rim 20 so as to form a tapered cone-like funnel having openings on both ends and a lumen 25 connecting the two openings. Below the first rim 15 attached to the inner surface 35 of the disposable cover is a ledge 45 that extends into the lumen 25. The ledge 45 is configured to extend only slightly into the lumen 25 so as not to fully obstruct the passageway of the lumen 25. The ledge 45 is configured to contact the dispensing end of a toothpaste dispenser. The inner surface 35 is also equipped with at least one barb 40, preferably 2 barbs, that is/are configured to releasably engage a portion of the dispensing end of a toothpaste dispenser.

FIG. 2 shows a top view of the disposable cover wherein the second rim 20 is larger in diameter than the first rim 15 and the ledge 45 is located within the lumen 25 of the disposable cover 10.

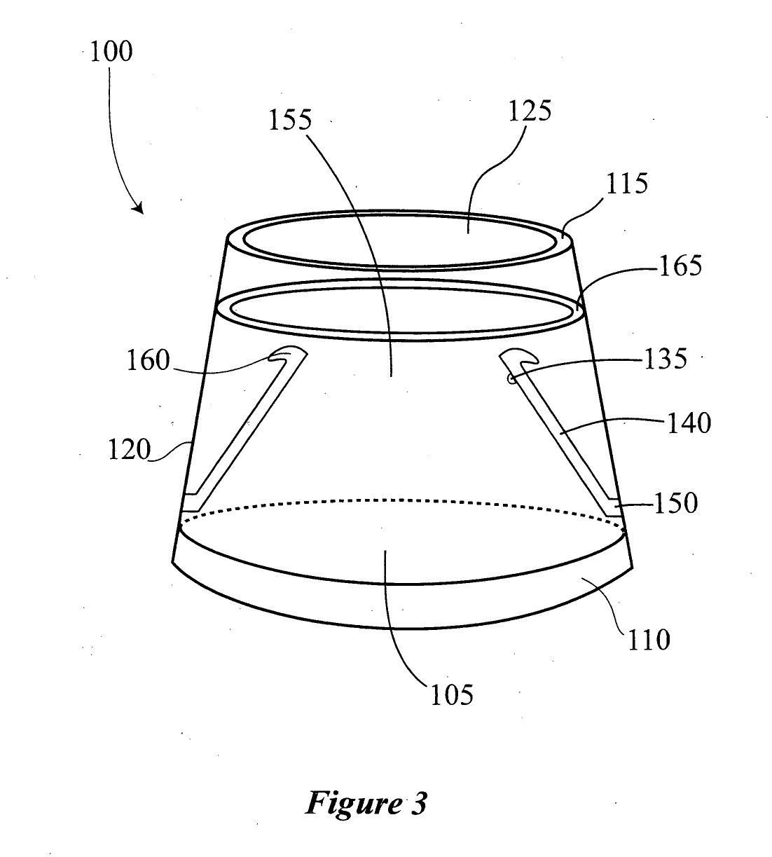

FIG. 3 shows the deposable cover 10 discussed above positioned on a toothpaste dispenser 205 as a single unit 200. In this figure, the disposable cover 10 is positioned on the dispensing end 215 of the toothpaste dispenser 205 with the second rim 20 placed farther onto the toothpaste dispenser 205 than the first rim 15 of the disposable cover 10. In this position the dispensing end 215 is engaged by the barbs 40 and the dispensing end 215 of the toothpaste dispenser 205 is in closed proximity to, if not in direct contact with, the ledge 45. In this orientation the toothpaste dispenser 205 can be squeezed or pumped to release toothpaste 220 out of the dispensing end 215 of the dispenser 205 into the lumen 25 and out of the first opening of the disposable cover 10 defined by the first rim 15. This allows a user to dispense toothpaste form a toothpaste dispenser 205 onto a toothbrush without ever coming in direct contact with the dispensing end 215 of the toothpaste dispenser 205 thereby preventing the transfer of diseases and germs.

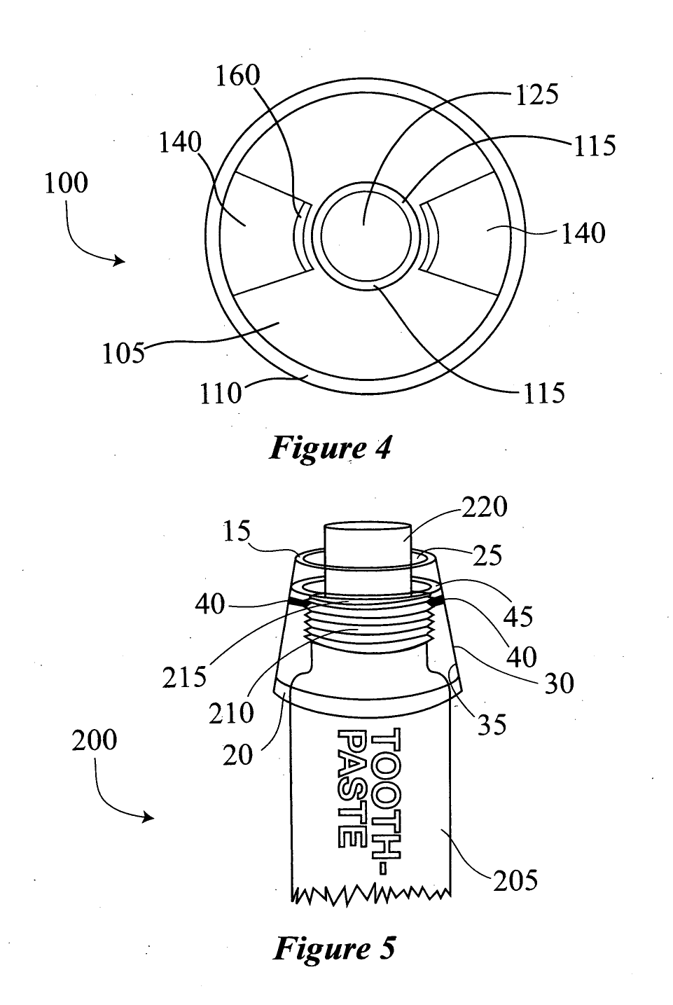

FIG. 4 shows a partial sectional side view of one embodiment of the disposable cover of the present invention. This embodiment of the disposable cover of the present invention is configured in almost the same way as the embodiment shown in FIG. 1 except that it has a securing flap 140 attached to the inner surface 120 of the deposable cover 100. As with the embodiment shown in FIG. 1, this embodiment has an outer surface 130 and inner surface 120 as well as a first rim 115 and a second rim 110. The first rim 115 defines the outline of a first opening 125 and the second rim 110 defines the outline of a second opening 105. The first and second rims 115 and 120 are configured so as to be in-line and separated apart from one another. The first and second openings 125 and 105 are connected by a lumen 155 that is defined by the inner surface 120 of the disposable cover 100.

Below the first rim 115 attached to the inner surface 120 of the disposable cover 100 is a ledge 165 that extends into the lumen 155. The ledge 165 is configured to extend only slightly into the lumen 155 so as not to fully obstruct the passageway of the lumen 155. The ledge 165 is configured to contact the dispensing end of a toothpaste dispenser and/or prevent the dispensing end of the toothpaste dispenser from being exposed.

As shown in FIG. 4, the first rim 115 has a diameter that is smaller than the diameter of the second rim 110 so as to form a tapered cone-like funnel having openings on both ends and a lumen 155 connecting the two openings 125 and 105. Just above the second rim 110 attached to the inner surface 120 of the disposable cover 100 is at least one, preferable two securing flaps 140 having a curved end 160 and being attached to the inner surface 120 by a hinge member 150. The securing flaps 140 further comprise at least one barb 135 to releasably engage a portion of the dispensing end of a toothpaste dispenser. The securing flaps are made of a material having a built in memory so that it returns back to the original position when not in contact with the dispensing end of the toothpaste dispenser. That is, when the securing flaps 140 are distorted by the dispensing end of a toothpaste dispenser, the flaps bend towards the inner surface 120 of the deposable cover 100 and exert pressure onto the dispensing end of the toothpaste dispenser. Once the disposable cover is remove for the toothpaste dispenser, the securing flaps 140 return back to their original position.

FIG. 5 shows a top view of the disposable cover 100 as it rests on the first rim 115 having opening 125 and the second rim 110 having opening 105. Two securing flaps 140 each having a curved edge 160 are attached to the inner surface of the disposable cover. The edges 160 of the securing flaps 140 are curved inwards so as to prevent the securing flaps 140 from becoming lodged against the dispensing end of the toothpaste dispenser when it is positioned within the disposable cover 100.

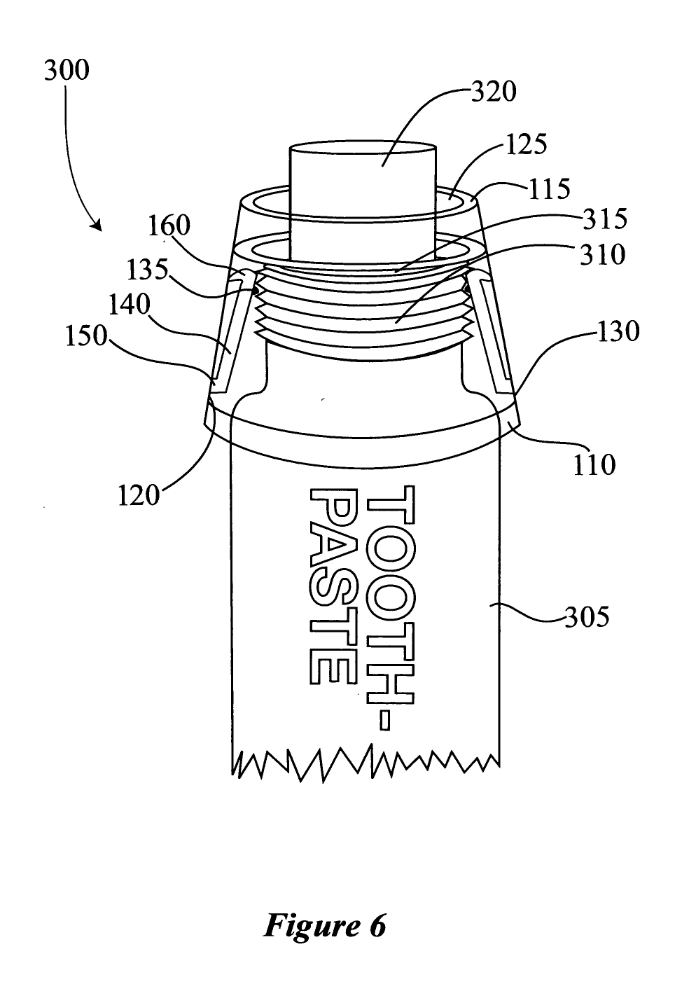

FIG. 6 shows the deposable cover 100 discussed above positioned on a toothpaste dispenser 305 as a single unit 300. In this figure, the disposable cover 100 is positioned on the dispensing end 315 of the toothpaste dispenser 305 with the second rim 110 positioned farther onto the toothpaste dispenser 305 than the first rim 115 of the disposable cover 100. In this position, the dispensing end 315 is engaged by the barbs 135 located on the securing flaps 140 which are pressed closer to the inner surface 120 of the disposable cover 100. This distortion of the securing flaps 140 exerts pressure on the dispensing end 310 of the toothpaste dispenser 305 which is releasably engaged by the barbs 135 located on the securing flaps 140. The dispensing end 315 of the toothpaste dispenser 305 is in closed proximity to, if not in direct contact with, the ledge 165.

In this orientation the toothpaste dispenser 305 can be squeezed or pumped to release toothpaste 320 out of the dispensing end 315 of the dispenser 305 into the lumen 155 and out of the first opening 125 of the disposable cover 100 defined by the first rim 115. This allows the user to dispense toothpaste form a toothpaste dispenser 305 onto a toothbrush without ever coming in direct contact with the dispensing end 315 of the toothpaste dispenser 305 thereby preventing the transfer of bacteria, viruses, and other germs.

Once the toothpaste has been dispensed the disposable cover can be pulled and/or squeezed the pulled off of the dispensing end 315 of the toothpaste dispenser 305 for proper disposal. As stated above, this prevents the transfer of communicable diseases such as Strep throat, common cold, influenza, gingivitis and other diseases that can be transferred by saliva.

The disposable cover of the present invention can be equipped with strategically placed dimples that when depressed cause the disposable cover to flex and pop off of the toothpaste dispenser. The disposable cover can also be equipped with a quick release that aids in removing the cover when depressed. The deposable cover can be made of flexible materials such as plastic, silicone based rubbers, paper, waxed covered paper, manmade materials or any other flexible material. The covers can be made using molds, die-cut from sheets of material or any other method know in the art.

The present invention is also directed to a kit comprising a toothpaste dispenser, a plurality of disposable covers, and optionally a dispenser for the disposable cover and a toothbrush.

Finally, the present invention is also directed to a method for providing toothpaste in a hygienically acceptable manner so as to prevent the transfer of germs from a toothbrush to the toothpaste dispenser and the to the next user of the toothpaste dispenser. The method uses any of the disposable covers of the present invention to cover the dispensing end of the toothpaste dispenser and once the toothpaste is dispensed the cover is removed and properly disposed. Prior to using the toothpaste dispenser again a new disposable cover is applied and the process is repeated.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A disposable toothpaste dispenser cover comprising
a body having an outer surface, an inner surface, a first rim and a second rim, said first and second rim defining a first opening and a second opening;
said first and second rims positioned in-line and apart from one another so as to define a lumen that extends from said first rim to said second rim; and
at least one barb attached to said inner surface, said at least one barb configured to releasably engage said toothpaste dispenser so as to retain said disposable toothpaste dispenser cover on said toothpaste dispenser when toothpaste is being dispensed and configured to be removable from said toothpaste dispenser after toothpaste has been dispensed.

2. The disposable toothpaste dispenser cover of claim 1 wherein said first rim is smaller in diameter than said second rim so as to form a funnel shaped cover, said funnel shaped cover configured to cover the outside portion of said toothpaste dispenser without blocking the flow of toothpaste from said dispenser and to prevent direct contact between said toothpaste dispenser and a toothbrush.

3. The disposable toothpaste dispenser cover of claim 2 further comprising a plurality of friction lines positioned on said inner surface of said toothpaste dispenser cover and configured to engage at least a portion of said toothpaste dispenser.

4. The disposable toothpaste dispenser cover of claim 1 constructed from a semi-rigid flexible material configured so that when said disposable toothpaste dispenser cover is squeezed inwardly said at least one barb disengages from said toothpaste dispenser thereby releasing it from said toothpaste dispenser.

5. The disposable toothpaste dispenser cover of claim 4 further comprising two dimples located on said outside surface of said disposable toothpaste dispenser cover, said dimples positioned on said outer surface of said disposable cover and configured so that squeezing inwardly on said dimples distorts said disposable toothpaste dispenser cover and disengage said at least one barb from said toothpaste dispenser thereby releasing it from said toothpaste dispenser.

6. The disposable toothpaste dispenser cover of claim 1 further comprising an inner rim attached to said inner surface of said toothpaste dispenser cover, said inner rim configured to contact at least a portion of a dispensing orifice of said toothpaste dispenser positioned within said lumen of said disposable cover thereby preventing direct contact between said dispensing orifice and said toothbrush.

7. A disposable toothpaste dispenser cover comprising
a body having an outer surface, an inner surface, a first rim and a second rim, said first and second rim defining a first opening and a second opening;
said first and second rims disposed in-line and apart from one another defining so as to define a lumen that extends from said first rim to said second rim;
a securing flap connected to said inner surface of said disposable cover, said securing flap having a built in memory; and
at least one barb attached to said securing flap, said at least one barb configured to releasably engage said toothpaste dispenser so as to retain said disposable toothpaste dispenser cover on said toothpaste dispenser when toothpaste is being dispensed and configured to be removable from said toothpaste dispenser after toothpaste has been dispensed.

8. The disposable toothpaste dispenser cover of claim 7 wherein said securing flap is configured to be displaced towards said inner surface of said disposable cover when said disposable cover is positioned on said toothpaste dispenser thereby applying pressure to said toothpaste dispenser positioned within said lumen so as to secure engagement.

9. The disposable toothpaste dispenser cover of claim 7 wherein said first rim is smaller than said second rim so as to form a funnel shaped cover, said funnel shaped cover configured to cover at least a portion of said toothpaste dispenser without blocking the flow of toothpaste from said dispenser, said disposable cover preventing said toothpaste dispenser from coming in direct contact with a toothbrush so as prevent the transfer of germs.

10. The disposable toothpaste dispenser cover of claim 7 further comprising a plurality of friction lines on said securing flap and/or said inner surface of said toothpaste dispenser cover, said friction lines configured to grip at least a portion of said toothpaste dispenser upon placement thereon.

11. The disposable toothpaste dispenser cover of claim 7 constructed from a semi-rigid flexible material configured so that when said disposable toothpaste dispenser cover is squeezed inwardly said at least one barb disengages from said toothpaste dispenser thereby releasing it from said toothpaste dispenser.

12. The disposable toothpaste dispenser cover of claim 11 further comprising two dimples positioned on said outside surface of said disposable toothpaste dispenser cover so that squeezing inwardly on said dimples distorts said securing flap so as to disengage said at least one barb from said toothpaste dispenser thereby releasing said disposable cover from said toothpaste dispenser.

13. The disposable toothpaste dispenser cover of claim 7 wherein said securing flap has a first end and a second end, said first end attached to said inner surface of said disposable cover at a point proximal to said second rim and said securing flap configured to have a built in memory that flares away from said inner surface as it extends into said lumen.

14. The disposable toothpaste dispenser cover of claim 13 wherein said securing flap is configured to have a curled rounded second end that reduces resistance when said disposable toothpaste cover is pulled off of said toothpaste dispenser for disposal.

15. The disposable toothpaste dispenser cover of claim 7 further comprising an inner rim attached to said inner surface of said toothpaste dispenser cover, said inner rim configured to contact at least a portion of a dispensing orifice of said toothpaste dispenser positioned within said lumen of said disposable cover thereby preventing direct contact between said dispensing orifice and said toothbrush.

16. The disposable toothpaste dispenser cover of claim 7 further comprising a quick-release mechanism, said quick-release mechanism in communication with said securing flap and configured to detach said toothpaste dispenser cover from said toothpaste dispenser when activated.

17. A method for dispensing toothpaste from a toothpaste dispenser without directly contacting a toothbrush, said method comprising
placing said disposable toothpaste dispenser cover of claim 1 on said toothpaste dispenser so that a dispensing orifice of said toothpaste dispenser is positioned within said lumen of said disposable cover thereby protecting said dispensing orifice of said toothpaste dispenser from coming in direct contact with a toothbrush receiving said toothpaste from said dispenser;
dispensing toothpaste from said toothpaste dispenser onto said toothbrush; and
removing said disposable toothpaste dispenser cover from said toothpaste dispenser for proper deposal.

18. A method for dispensing toothpaste from a toothpaste dispenser without directly contacting a toothbrush, said method comprising
placing said disposable toothpaste dispenser cover of claim 7 on said toothpaste dispenser so that a dispensing orifice of said toothpaste dispenser is positioned within said lumen of said disposable cover thereby protecting said dispensing orifice of said toothpaste dispenser from coming in direct contact with a toothbrush receiving said toothpaste from said dispenser;
dispensing toothpaste from said toothpaste dispenser onto said toothbrush; and
removing said disposable toothpaste dispenser cover from said toothpaste dispenser for proper deposal.

19. A tooth care kit comprising
a toothpaste dispenser for dispensing toothpaste;
at least one said disposable toothpaste dispenser cover of claim 1 configured to fit said toothpaste dispenser; and optionally a toothbrush.

20. A tooth care kit comprising
a toothpaste dispenser for dispensing toothpaste;
at least one said disposable toothpaste dispenser cover of claim 7 configured to fit said toothpaste dispenser; and optionally a toothbrush.
